(19) United States
(12) Patent Application Publication
(10) Pub. No.: US 2024/0010432 A1
(43) Pub. Date: Jan. 11, 2024

(54) TRANSPORT SYSTEM FOR TRANSPORTING MATERIAL UNITS IN MATERIAL PROCESSING AND METHOD FOR TRANSPORTING MATERIAL UNITS

(71) Applicant: Harburg-Freudenberger Maschinenbau GmbH, Hamburg (DE)

(72) Inventor: Alexander Quast, Friesenhagen (DE)

(21) Appl. No.: 18/253,000

(22) PCT Filed: Nov. 15, 2021
(86) PCT No.: PCT/EP2021/081667

§ 371 Date: May 15, 2023

(30) Foreign Application Priority Data
Nov. 18, 2020 (DE) 10 2020 130 484.6

(51) Int. Cl. B65G 1/137

(52) U.S. Cl. CPC B65G 1/1376

(57) ABSTRACT

In an embodiment a transport system includes a container with a plurality of compartments and a loading device configured to load and/or unload the compartments, wherein the loading device includes a carrier plate configured to transport the material unit to the container and/or from the container and wherein each of the compartments has a floor configured to receive the material unit from the carrier plate or to transfer the material unit to the carrier plate.

### CROSS-REFERENCE TO RELATED APPLICATIONS

This application is a National Stage of International Application No. PCT/EP2021/081667, filed on Nov. 15, 2021, which claims priority to German Patent Application No. 102020130484.6, filed on Nov. 18, 2020, which are incorporated herein by reference in its entirety.

### TECHNICAL FIELD

The present invention relates to a transport system for transporting material units in material processing. The transport system may additionally serve for intermediate storage of the material units. The transport system is used, for example, in the mixing and further processing of rubber or silicone materials.

### BACKGROUND

Known are facilities for material processing, in which a material, for example a chemical in powder form and chemical mixtures, is weighed and packed into bags for further processing. The bags are partly printed with a barcode, which is intended to ensure the traceability of the weighed chemical. The bags are usually transported manually to the production lines for further processing, for example to a mixer. For example, the bags are manually placed in pallet boxes by a weighing device. Optionally, the bags are temporarily stored there and, if required, manually placed on a feed belt for further processing. Optionally, barcodes on the bags are manually recorded by barcode scanners when they are placed on the belt to prevent mix-ups and to ensure the useful life of the bags or chemicals fed into the process.

Due to the manual transport processes following weighing or when fed for further processing, the bags are often damaged and, in particular, can tear, causing material to be lost. This can result in incorrect quantities of material being fed into the process or, if the damage to the bag has been detected, a large amount of scrap being generated.

### SUMMARY

Embodiments provide an improved transport system for transporting a unit of material in material processing and a method for transporting a unit of material.

According to a first embodiment of the present invention, a transport system for transporting at least one unit of material in material processing comprises a container having a plurality of compartments. In particular, the container may be a weighed unit of material. In particular, the container may be in the form of a shelf. The compartments may be arranged in a plurality of rows and/or columns, one above the other or side by side. For example, each compartment is configured to hold at most one unit of material. However, it is also possible that several, for example two smaller material units, are arranged in the compartment. The material units are, for example, in powder form and can be packaged in bags.

The transport system also has a loading device for loading and/or unloading the compartments of the container. The loading device can be designed to switch between loading and unloading depending on the mode of operation. In a facility, for example, the loading device may be movable between a loading station and an unloading station. It may also be provided that separate loading devices are provided in a facility for loading and unloading, respectively.

The loading device has a carrier plate for transporting the material units to and/or from the container. The compartments of the container each have a floor for receiving the material units from the carrier plate and/or for transferring the material units to the carrier plate. The carrier plate may be designed as a conveyor belt. Alternatively or additionally, the floors may be designed as further conveyor belts. Depending on the running direction of the conveyor belt and/or the further conveyor belts, unloading or loading of the container can thus take place.

In this way, the material units can be transported automatically and gently between the carrier plate of the loading device and the shelfs. In particular, the transport system can be designed in such a way that the material units are transferred between the loading device and the container without gripping and without falling of the material units. This prevents damage to the material units during transport and increases process reliability.

For example, the transport system is located at a dispensing station for delivering the material units, such as a material delivery of a weighing device. For example, the material units are automatically transferred from a conveyor belt of the weighing device to the carrier plate, in particular a conveyor belt, of the loading device. The transport system can also be located at a receiving station for receiving the material units for further processing, such as a feeder of a mixer. From the carrier plate of the loading device, the material units are, for example, automatically transferred to a conveyor belt or another feed of the receiving station.

If the carrier plate is designed as a conveyor belt and the shelfs as further conveyor belts, for example, the conveyor belt of the loading device is designed to drive the further conveyor belts. In particular, the conveyor belt can be designed to selectively drive one of the further conveyor belts. Thereby, after defining a compartment to be loaded or unloaded, the conveyor belt can be coupled to the further conveyor belt of the selected compartment. In particular, a movement of the conveyor belt can generate a movement of the further conveyor belt in the same direction of movement.

In this case, an additional drive for driving the further conveyor belts is not necessary. Alternatively, however, it is also possible to equip the container with one or more additional drives for driving the further conveyor belts. This can simplify retrofitting existing facilities with the conveyor system or even just the container system.

For coupling the conveyor belt with one of the further conveyor belts, the conveyor belt of the loading device has, for example, a first coupling element. The other conveyor belts each have a second coupling element, for example. The coupling elements are designed to be mechanically coupled to each other for loading and/or unloading.

For example, the coupling elements can be in the form of rollers, in particular rubber rollers. For the correct adjustment of the running direction of the further conveyor belt, a transmission can be present. The transmission may be part of the container and/or part of the loading device. For example, a transmission is arranged on a drive element of the conveyor belt. Both the drive element and the transmission may be designed as rollers, for example. The transmission can simultaneously function as a first coupling element and a second coupling element, respectively.

It is also possible that the shelfs of the container and/or the carrier plate of the loading device are designed to be inclined at least during material transfer. In this way, a transfer between the loading device and the container can also take place at least partially by sliding of the material unit by the weight of the material unit. The sliding can also be supported, for example, by rollers or other elements.

The trays or carrier plate may include a wall to stop the unit of material at a desired position. For example, the compartments have a selectively openable wall on an unloading side of the container. For example, the wall may be configured to open to transfer the unit of material between the container and the loading device. In particular, the wall may be in the form of a flap. The floors and/or the carrier plate may also be permanently inclined. Alternatively, the floors and/or the carrier plate can only be inclined for transfer.

In one embodiment, the carrier plate is designed as a conveyor belt and the shelfs are inclined. In particular, the shelfs in this case are not designed as conveyor belts. The conveyor belt of the loading device can be designed to be inclined during transfer to the compartments. In this case, the conveyor belts can also be inserted far into the interior of the compartments so that a gentle transfer of the material unit at the desired location is made possible. It is also possible, for example, that the carrier plate is not designed as a conveyor belt and is merely inclined for transfer. In this case, the trays can be designed as conveyor belts or can also only be inclined at least for transfer.

The transport system can have one or more positioning devices for mutual vertical or horizontal positioning of the carrier plate and the container. Thus, the carrier plate can be positioned at the compartment to be loaded or unloaded.

For example, the loading device has a positioning device for vertical positioning of the carrier plate. For example, this is a belt elevator with which the carrier plate can be moved up and down. In principle, it is also possible to move the container vertically and thus establish a vertical positioning with respect to the conveyor belt. For example, a transport vehicle, for example also a lifting device, can be used for this purpose.

In addition, the transport system can have a further positioning device for horizontal positioning of the container on the carrier plate so that, for example, one of the compartment gaps of the container is positioned at the carrier plate. The further positioning device can, for example, shift the container. In principle, it is also possible to shift the carrier plate horizontally.

The loading device can have a shifting device for shifting one end of the carrier plate, in particular a conveyor belt. In particular, the shifting device is designed to shift an end of the carrier plate facing the container during loading and unloading in the direction of the container and away from the container. In this way, the carrier plate can be positioned at the compartment to be loaded or unloaded in a first step, and thereafter the end of the carrier plate can be shifted towards the container, for example to enable coupling of coupling elements of conveyor belts. After the loading or unloading operation, the end of the carrier plate can be shifted away from the container. In particular, the shifting device may be configured to shift the end of the carrier plate but not the entire loading device. For example, it is possible to extend the carrier plate as a whole or to displace the carrier plate relative to a carrier of the loading device.

The loading device can also be in the form of a robot, for example. The carrier plate is arranged on a robot arm, for example. A loading device designed as a robot can, for example, enable the carrier plate to be moved in all three spatial directions. In addition, the carrier plate can also be attached to the robot arm in a tiltable manner.

The compartments of the container can each have at least one marking, in particular an electronically readable marking. For example, this is an RFID marking. The marking can be used for targeted loading and/or unloading of one of the compartments. Thus, for example, a compartment can be approached in a targeted manner. It is also possible to load and unload the containers from different sides. In this case, for example, each compartment has a marking on a loading side and another marking on an unloading side.

Information on a material unit stored in the respective compartment can also be determined from the marking of a compartment. For example, the marking includes this information or the information is linked to the marking, for example in a memory of a control unit. The data may include, for example, the weight of a weighed unit of material, the date of manufacture, a useful life and/or a chemical composition of the material. In this way, accurate traceability of the material unit information and the position of the respective material unit in the container is possible.

The transport system can have a checking device for checking the weight of a material unit. If the actual weight determined does not match the weight stored, for example with the marking, the material unit is removed from the process. The checking device is integrated in the loading device, for example. It is also possible that the checking device is arranged upstream of the loading device during loading and downstream of the loading device during unloading. The checking device has, for example, a conveyor belt that transfers a material unit to the loading device or takes it over from the loading device.

According to another embodiment of the present invention, a facility for material processing is disclosed. The facility comprises one or more transport systems for transporting at least one material unit. The transport system may be configured as previously described. In particular, the transport system may be configured to transport one or more units of material from a dispensing station, such as an outlet of a weighing device, to a receiving station, such as a feed of a mixer. For example, the system may be configured to process rubber or silicone materials.

The system may also include two or more such transport systems, one of the transport systems being located at the dispensing station for loading a container with units of material and one of the transport systems being located at the receiving station for unloading the container with the units of material.

According to another embodiment of the present invention, a use of a transport system in a facility for material processing is disclosed. In particular, the transport system and the facility may be as previously described. For example, the transport system may be configured to retrofit an existing facility.

According to a further embodiment of the present invention, a method for transporting at least one unit of material in material processing is disclosed. In particular, the method may be performed using the previously described transport system. In the method, a container having a plurality of compartments and a loading device for loading and/or unloading the compartments are provided.

For example, a conveyor belt of the loading device is positioned at another conveyor belt of one of the compartments and a unit of material is transferred between the conveyor belts.

In particular, during a loading of the container, a material unit arranged on the conveyor belt of the loading device is transferred to the further conveyor belt of one of the compartments. When unloading the container, a material unit arranged on the further conveyor belt of one of the compartments is transferred to the conveyor belt of the loading device. In particular, the transfer is fully automatic and gentle, so that damage to the material unit is avoided.

The further conveyor belt can be driven by the conveyor belt of the loading device. In addition, a weight check of the conveyed material unit can be carried out before loading or after unloading. The process can be controlled by a control unit. In this process, for example, an identification of the compartments can be read out and thus information on the compartment position of a particular material unit and further information on the material unit, such as weight, date of manufacture, shelf life and composition, can be obtained and processed.

It is also possible for the floors to have an inclination. In this case, the material units can slide towards an unloading side due to their weight. In addition or alternatively, the carrier plate can also be inclined for transfer. In this case, the carrier plate may be designed as a conveyor belt, so that the inclination enables insertion into a compartment with an inclined shelf. Alternatively, the carrier plate may not be designed as a conveyor belt and an inclination of the carrier plate may allow a transfer due to the weight of the material.

After loading the container, the container can optionally be stored temporarily until one of the material units is required for further processing.

The present invention encompasses several embodiments, in particular devices and methods. The features, characteristics described for one of the embodiment are intended to apply accordingly to the other embodiment.

Moreover, the description of the subject matters given here is not limited to the specific embodiments. Rather, the features of the individual embodiments can be combined with each other—to the extent that this makes technical sense.

### BRIEF DESCRIPTION OF THE DRAWINGS

In the following, the present invention described herein are explained in more detail by means of schematic embodiment examples.

FIG. 1 shows a diagram of a transport system comprising a container and a loading device;

FIG. 2 shows an embodiment of a transport system comprising a container and a loading device in schematic view;

FIG. 3 shows a diagram of a process flow when loading and unloading a container by means of a loading device; and

FIG. 4 shows a further embodiment of a transport system comprising a container and a loading device in schematic view.

Preferably, in the figures, the same reference signs refer to functionally or structurally corresponding parts of the various embodiment.

### DETAILED DESCRIPTION OF ILLUSTRATIVE EMBODIMENTS

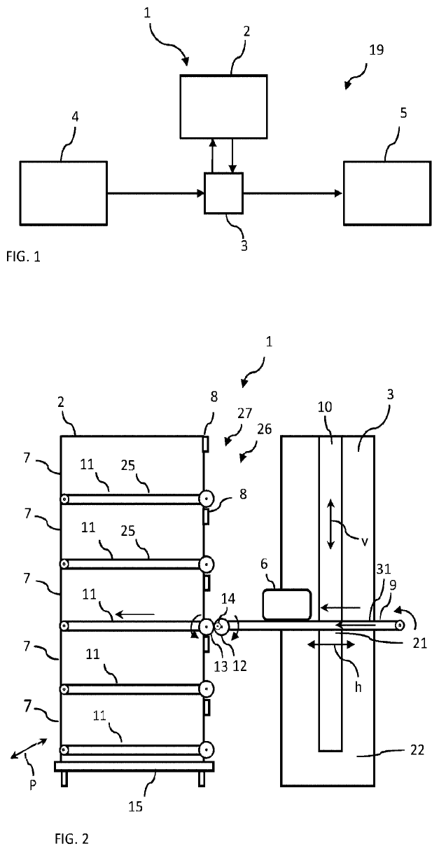

FIG. 1 schematically shows a transport system 1 in a facility 16 for material processing and an associated process flow. The transport system 1 comprises a container 2 for receiving material units and a loading device 3 for unloading and/or loading the container 2.

The facility 16 in which the transport system 1 is used is used, for example, for processing and manufacturing silicone or rubber materials, such as tires or other technical rubber goods. In such facilities 16, for example, materials, such as chemicals required for production, are weighed in a weighing device before they are sent for further processing. By means of the transport system 1, a material unit is transported from a dispensing station 4, for example a material delivery of a weighing device, to a receiving station 5, for example a material feed of a further processing.

The further processing comprises, for example, a mixing device in which a material unit is mixed with other material components. In this case, the transport system 1 ensures that a material unit passes from the dispensing station 4 to the receiving station 5 with as little mechanical stress as possible, such as stress caused by lifting, pushing, falling, pressing, etc., for example.

For example, the weighing device is fully automatic. For example, a powdered material is weighed and filled into a bag. The bag is sealed, for example, to minimize material loss during transport and/or optional storage. The bag is, for example, low melting with a melting temperature between 60° C. and 70° C. Such bags are very fragile and can be easily damaged during processing, resulting in loss of weighed material. On the other hand, such bags can be fed into the mixing facility together with their contents. Only if the bags are thin-walled and made of a low-melting material it can be ensured that they dissolve completely in the material mixture. The transport system 1 can in particular ensure that sensitive bags are not damaged during transport and that no material is lost. This is particularly important in view of the fact that a bag with, for example, 20 kg contents contains some additives only in the gram range. The loss of only a few grams of material can therefore mean that one of the additives is completely missing.

The further processing unit connected to the receiving station 5 comprises, for example, a feed for the material unit and further feeds for feeding further material components. The material unit is fed to a mixing device by a conveyor belt of the receiving station 5, for example. In the case of mixing the material with other material components, the further processing comprises, for example, a mixer. In addition, the further processing may comprise other components such as an extruder, a rolling mill for producing a sheet of the material, and/or a batch-off facility. For example, a batch-off facility may apply an anti-adhesive to a sheet of the material mixture.

The transport system 1 can be fully automated. For example, the material units are automatically taken over by the loading device 3 at a loading station, transferred to the container 2, later removed from the container 2 by this or another loading device 3 and delivered again at an unloading station, so that no manual transport of the material units is carried out.

FIG. 2 shows in a schematic sectional view a transport system 1 in a loading process of the container 2 with a material unit 6. The container 2 has a plurality of compartments 7 for depositing one material unit 6 each. In addition to the compartments 7 shown here arranged one above the other, the container 2 can also have compartments 7 additionally or alternatively arranged side by side. For example, the container 2 has several rows of compartments 7 arranged side by side and several rows of compartments 7 arranged one above the other.

Each of the compartments 7 can be provided with a marking 8 that can be read electronically. For example, this is an RFID marking. In this way, a compartment 7 can be uniquely identified and it can be unambiguously determined in which compartment 7 a particular unit of material 6 is accommodated. For example, a link between compartment 7 and information on the material such as exact weight and date of manufacture can thus be stored. A readout of the marking 8 takes place, for example, during loading and unloading of the material unit 6.

After weighing, the weighed material unit 6 is arranged on a carrier plate 31 of the loading device 3. The carrier plate 31 is designed as a conveyor belt 9. For example, the material unit 6 is automatically transferred from another conveyor belt of a dispensing station 4 to the conveyor belt 9 of the loading device 3. The loading device 3 has a positioning device 10 for vertically positioning the conveyor belt 9 and thus the material unit 6, so that a specific one of the compartments 7 of the container 2 is approached. The vertical shiftability of the conveyor belt 9 is represented by a double arrow with referencing v. The positioning device 10 is designed, for example, in the form of a belt elevator.

During the positioning process, the marking 8 of the approached compartment 7 can be read out and processed in a higher-level control system. During the positioning process, the conveyor belt 9 is positioned at a horizontal distance from the container 2 so that the conveyor belt 9 can be moved vertically without hindrance until it has reached a desired compartment position.

Each compartment 7 has a floor 25 for receiving the material unit 6 in the compartment 7. The floors 25 are designed as further conveyor belts 11. The material unit 6 is transferred from the conveyor belt 9 of the loading device 3 to the further conveyor belt 11 with as little impact as possible. For loading, when the compartment 7 to be loaded is detected, the conveyor belt 9 is first positioned vertically above the further conveyor belt 11.

The end of the conveyor belt 9 facing the container 2 is then shifted horizontally a short distance in the direction of the container 2 so that a mechanical coupling can be established between the conveyor belt 9 and the further conveyor belt 11. The horizontal shiftability is indicated here by a double arrow with the referencing h. For example, the conveyor belt 9 is shifted as a whole a distance in the direction of the container 2 by means of a shifting device 21. The shifting device 21 is integrated in the positioning device 10, for example. By means of the shifting device 21, the conveyor belt 9 is shifted relative to a base frame 22 of the loading device 3. It is also possible to change the belt length of the conveyor belt 9, so that one end of the conveyor belt 9 is shifted in the direction of the container 2 without the entire conveyor belt 9 being shifted.

The conveyor belt 9 has a first coupling element 12, which is designed for mechanical coupling with a second coupling element 13 of the respective further conveyor belt 11. The coupling elements 12, 13 are designed, for example, as rollers, in particular as rubber rollers. A movement of the conveyor belt 9 is translated into a movement of the further conveyor belt 11 via the coupling elements 12, 13. The ratio is, for example, 1:1, with the first coupling element 12 being designed as an active drive element for driving the passive second coupling element 13. Thus, the conveyor belt 9 is active and the further conveyor belt 11 is passive.

During loading, the further conveyor belt 11 is approached from above until a mechanical contact of the first coupling element 12 with the second coupling element 13 is established. The mechanical contact can be detected electrically by an increase in resistance during vertical positioning of the conveyor belt 9. As soon as the contact is established and the coupling elements 12, 13 are thus coupled, the vertical shifting of the conveyor belt 9 is stopped.

Then the conveyor belt 9 is driven so that the material unit 6 is moved in the direction of the compartment 7 to be loaded. When the conveyor belt 9 moves, the first coupling element 12 is also set in motion, in particular in rotation. As a result of the coupling, the movement is transmitted to the second coupling element 13. For setting the correct transmission of the directions of movement of the conveyor belts 9, 11, the first coupling element 12 can be designed as a transmission coupled to a drive element 14, in particular a shaft, which is directly coupled to the conveyor belt 9. The first coupling element 12 is thereby arranged laterally at the outside of the conveyor belt 9, so that the material units 6 do not come into contact with this coupling element 12. Thus, the further conveyor belt 11 is moved in the same direction as the first conveyor belt 9. Alternatively, a transmission can be integrated into the further conveyor belt 11.

The further conveyor belt 11 takes up the material unit 6 from the conveyor belt 9 and places the material unit 6 in the compartment 7. The conveyor belts 9, 11 are positioned in such a way that the transfer of the material unit 6 is as smooth as possible. Due to the drive of the further conveyor belt 11 by the conveyor belt 9, no additional drive is required for the further conveyor belt 11. However, it is also possible to drive the further conveyor belt 11 by one or more additional drives, which are integrated in the container 2, for example.

When the material unit 6 has reached a desired position in the compartment 7, the conveyor belt 9 is stopped, which also stops the movement of the further conveyor belt 11. Reaching the desired position can be determined by a predetermined traverse of the conveyor belts 9, 11 or by a sensor. The further conveyor belt 11 can then be fixed in its position, for example by a mechanical locking device.

The loading device 3 may have an alignment unit to ensure a consistent loading pattern of the material units 6 in the compartments 7 during loading.

After loading one of the compartments 7, the conveyor belt 9 is moved up again so that the coupling elements 12, 13 are decoupled. Subsequently, one end of the conveyor belt 9 is moved back a short distance from the container 2 by means of the shifting device 21, so that a new compartment 7 can be approached for further loading, after possible new loading of the loading device 3 with a material unit 6. It is also possible that the conveyor belt 9 is moved back directly after loading without the conveyor belt 9 being moved up first.

A further positioning device 15 can be provided for horizontal positioning of the container 2 relative to the loading device 3. The positioning is represented here by a double arrow with the referencing “P”. The further positioning device 15 has, for example, a carrier on which the container 2 is arranged. The carrier or, for example, a roller system on the carrier can, for example, shift the container 2 horizontally.

For example, the container 2 is moved when a column of compartments 7 arranged one above the other is completely filled with material units 6. Subsequently, a new column of compartments 7 arranged one above the other can be filled by means of the loading device 3. It is also possible to move the loading device 3 horizontally by means of a positioning device. It is also possible to position the container 2 at the loading device 3 by means of a transport system, for example an automated guided vehicle (AGV), a forklift truck or a chain conveyor, and to move it horizontally if necessary.

The container 2 can be filled completely so that after filling there is exactly one weighed material unit 6 in each compartment. The container 2 can also be filled only partially. After loading, the container 2 can optionally serve for intermediate storage of the material units 6. For this purpose, the container 2 may be transported by a transport vehicle, for example an automated guided vehicle (AGV) to a location for temporary storage. For example, the container 2 can be flexibly stored in areas or a high-bay storage until it is used.

Alternatively, the container 2 can also be taken directly to a receiving station 5 of further processing. For example, one or more weighed material units 6 are unloaded from the container 2 by means of a loading device 3.

The loading device 3 for unloading can be designed in the same way as the loading device 3 for loading. The process for unloading can be carried out in the same way as for loading, only in the reverse direction of rotation of the conveyor belts 9, ii. Furthermore, during unloading, the further conveyor belt 11 is approached from below by the conveyor belt 9 of the loading device 3 in order to ensure the smoothest possible transfer of the material unit 6 from the further conveyor belt 11 to the conveyor belt 9. The container 2 can be loaded and unloaded from the same side, so that the loading side 26 corresponds to the unloading side 27. In principle, it is also possible to perform loading and unloading from different sides.

The loading device 3 can be designed as a loading device, as an unloading device, or both. For example, the loading device 3 can be designed as a loading device and permanently positioned at the dispensing station 4. Alternatively, the loading device 3 may be configured as an unloading device and permanently positioned at the receiving station 5. Thus, a material processing system 16 may have two such loading devices 3, one loading station being configured as a loading station and another loading station being configured as an unloading station. It is also possible to move the same loading device 3 back and forth between dispensing station 4 and receiving station 5.

The loading device 3 can be equipped with a control system for both loading and unloading, which performs a check of the material units 6 during loading and unloading and sorts out material units 6 if necessary.

FIG. 3 shows a diagram of a process sequence with control system during loading and unloading of a container 2 by means of loading devices 3, 3′. At the same time, the diagram schematically shows a possible arrangement of the components in a facility 16 for material processing.

The weighed material unit 6 is delivered to the transport system 1 at a loading station 23 from a dispensing station 4, which is designed, for example, as a weighing device. The weighed material unit 6 is packaged in bags, for example, and provided with a marking that indicates, for example, the total weight, the composition and the date of manufacture. The marking is printed on the bag, for example, as a barcode. However, a barcode is no longer absolutely necessary due to the marking 8 of the compartments 7.

For example, the material unit 6 is transferred from a conveyor belt of the dispensing station 4 to the conveyor belt 9 of the loading device 3. Before this, the material unit 6 can still be subjected to a test weighing and aligned in order to ensure an accurate transfer. For this purpose, an alignment unit can be provided which, for example, has a type of funnel through which the material unit 6 passes.

The transport system 1 comprises a checking device 17 for checking the weight of the material units 6. In particular, the total weight of the bag and the material contained therein can be checked. If the actual weight does not match the expected weight, the weighed material unit 6 is sorted out. For example, this may be the case if the bag is damaged. The sorting out can be done automatically, for example via the checking device 17 or the loading device 3. The sorting out can also be done manually when a signal is given. If the actual weight matches the expected weight, the weighed material unit 6 is optionally still aligned and then transferred to the conveyor belt 9 of the loading device 3. The control device 17 can also be integrated into the conveyor belt 9.

After the container 2 has been loaded by the loading device 3, as described in connection with FIG. 2, the container 2 can optionally be transported to an intermediate storage station 18 and stored there until the material units 6 are required for further processing.

After the optional intermediate storage, the container 2 is transported to an unloading station 24 and there the material units 6 are fed by means of a transport system 1′ to a receiving station 5, in particular to a further processing station. The transport to the unloading station is carried out, for example, by means of a transport vehicle, in particular a driverless transport vehicle.

The transport system 1′ comprises a loading device 3′ which is designed for unloading. This can be the same loading device 3 as in the transport system 1 for loading. The loading device 3′ for unloading can also be present in addition to the loading device 3.

After unloading a material unit 6 from the container 2 by the loading device 3′, the weight of the material units 6 is checked as in the transport system 1 for loading. For this purpose, the transport system 1′ has a checking device 17′ for checking the weight of the material unit 6. If the weight does not match the weight stored in the marking of the compartment 7, the material unit 6 is disposed of. This may be the case due to a defective bag.

For example, the control system 17′ has another conveyor belt that transports the material unit 6 to the receiving station 5 and simultaneously performs weighing. If the weighed weight does not correspond to the expected weight, the direction of travel of the conveyor belt is changed again, for example, so that the material unit 6 is conveyed back onto the conveyor belt 9 of the loading device 3. The loading device 3 can then dispose of the material unit 6 in a collecting container provided for rejects.

Instead of marking the material units 6 directly, for example via a barcode on the bag, the marking can also be stored exclusively in the marking 8 of an assigned compartment 7. A higher-level control system 20 can store the information on the material unit 6 together with the marking 8 in a database during loading and read out the features again during unloading. Thus, the identification 8 of the compartments 7 and a higher-level control system 20 enable almost 100% traceability. The control system 20 can also control the positioning and shifting devices, for example.

To compensate for possible defects in production, more material can be weighed than is required. If the weighed material is not completely used at one point in time, the control system 20 can ensure that the excess weighed material is fed to the next upcoming production of a corresponding product in a timely and prioritized manner.

The transport of the material unit 6 from the dispensing station 4 to the receiving station 5 can be fully automatic. In particular, there is no manual handling of the material unit 6 between the dispensing station 4 and the receiving station 5. For example, the material unit 6 is transported only via the shown system of carrier plate 31 and floors 25 and via the movement of the container 2. During transport, the material unit 6 does not have to be lifted, so that higher weights are possible without damaging the packaging, in particular a bag.

Gentle handling can reduce the risk of damage to the material units 6 during transport and optional storage, so that scrap can also be reduced. Thus, the sustainability of the manufacturing process is increased. The reduction in scrap can also increase the efficiency of the process, as it is no longer necessary to resupply material to replace the scrap.

Due to the marking 8 of the compartments 7 and the assignment of the compartment 7 to the properties of the material unit 6 stored there, 100% tracking is possible. In particular, only one material unit 6 is stored in a compartment 7, so that the assignment of compartment 7 to the material unit is unambiguous. By checking the weight during loading and/or unloading, it can be ensured that no damaged unit enters the processing operation. In addition, a so-called “first in-first out” system is also possible, so that a material unit 6 that is placed first in the container 2 is also the first to be removed. This can prevent units from being stored for too long and for this reason no longer being usable.

It is also possible in a simple manner to retrofit existing facilities with the transport system 1, 1′, since the transport system 1, 1′ can be flexibly adapted to the type of dispensing station 4 and receiving station 5, and the container 2 can be designed to be compatible with the transport system 1, 1′ used. In addition, the size of the container 2 can be adapted to already existing containers.

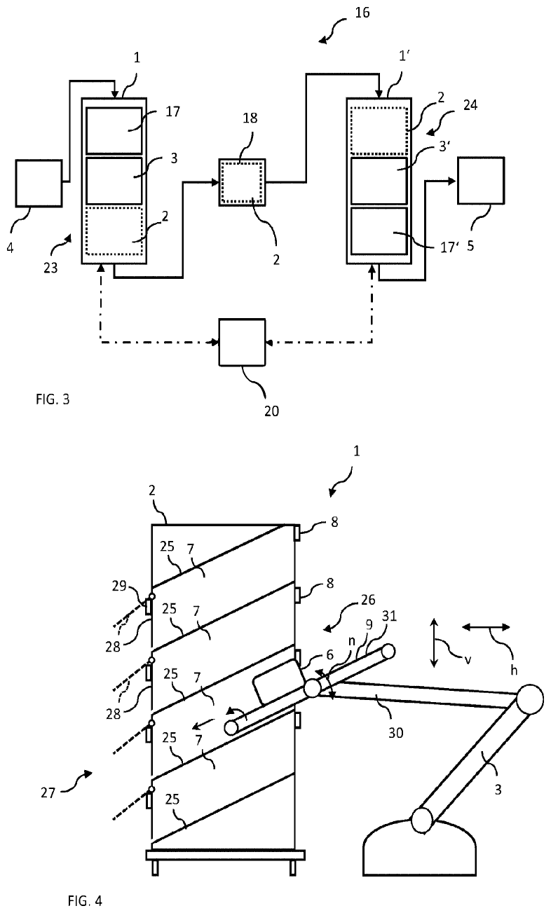

FIG. 4 shows a further embodiment of a transport system 1.

In contrast to the transport system shown in FIG. 2, the container 2 has compartments 7 with sloping floors 25. The floors 25 slope from a loading side 26 to an unloading side 27. Loading and unloading are carried out here from different sides. The sloping floors 25 allow the material unit 6 to slide at least a little way towards the unloading side 27 due to its weight, so that the compartments 7 do not require conveyor belts. It is also possible that the floors 25 are provided with rollers or similar elements to facilitate the sliding process.

In principle, loading can be carried out with a loading device 3 as shown in FIG. 2, as described below with reference to FIG. 2. In this case, the end of the conveyor belt 9 facing the container 2 is lead to the floor 25 of the compartment 7 to be filled, for example placed directly at the level of the floor 25 or above the floor 25. Subsequently, the conveyor belt 9 is driven so that the material unit 6 glides from the conveyor belt 9 onto the floor 25 and slides towards the unloading side 27.

The container 2 has flaps 28 on the unloading side 27, which are closed for transport and storage and can be selectively opened during unloading. During unloading, a conveyor belt 9 may be placed at the unloading side 27 at the level of the floor 25 or slightly below. For this purpose, the container 2 may have further markings 29 on the unloading side 27 so that the conveyor belt 9 can be positioned at the desired compartment 2. The further markings 29 may each contain the same information as the markings 8 associated with the same compartment 7.

The material unit 6 then slides slightly further down onto the conveyor belt 9 when the flap 28 is opened, which then gently transports the material unit 6 out of the container 2.

In the specific embodiment of FIG. 4, the loading device 3 is designed in the form of a robot, in contrast to the loading device of FIG. 2, in which the carrier plate 31, in particular a conveyor belt 9, is attached to a robot arm 30. Thus, the carrier plate 31 can also be positioned vertically and horizontally on the compartment 7 in this case. In addition, it is also possible that the robot arm 30 can be moved in such a way that a further positioning device 15 for horizontal positioning of the container 2 is not necessary. In particular, the robot arm 30 can be designed to approach compartments 7 arranged next to each other. Here, the carrier plate 31 is attached to the robot arm 30 in its central region. It is also possible, for example, for the carrier plate 31 to be attached to the robot arm 30 at an end facing away from the container 2.

In addition, the carrier plate 31 is designed to be inclinable. In particular, the carrier plate 31 can be aligned with the same inclination as the floor 25 during loading and/or unloading. The inclinability of the carrier plate 31 is represented by a double arrow with referencing n. This makes it possible to insert the carrier plate 31 far into the compartment 7 to be loaded during the loading process, so that the material unit 6 is already positioned within the compartment 7 when it is transferred to the container 2 and a sliding process in the direction of the unloading side 27 is minimized or completely eliminated. Thus, the material unit 6 can be transferred even more gently. Once the conveyor belt 9 has reached the desired position in the compartment 7, it is driven so that the material unit 6 is deposited in the compartment 7. The conveyor belt 9 can also be moved slowly out of the compartment 7 during the loading process, so that loading is as gentle as possible. The speed when moving out corresponds in particular to the belt speed of the conveyor belt 9.

It is also possible to design the loading device 3 like the loading device 3 of FIG. 2. Here, too, the conveyor belt 9 can be attached to the positioning device 10 in a tiltable manner. It is also possible that the conveyor belt 9 is not inclinable, so that the conveyor belt 9 is not moved into a compartment 7 at all or only for a short distance. In addition, the container 2 of the embodiment of FIG. 2 can also be loaded with the loading device 3 of FIG. 4. Furthermore, it is also conceivable that the loading device 3 can accomplish the delivery of the material unit 6 based solely on the weight of the material unit 6 and with an inclination of the carrier plate 31. Thus, it is also possible that the loading device 3 does not comprise a conveyor belt. Similarly, it is possible that the inclination of the floors 25 of the container 2 can be adjusted so that they slope towards the loading side 27 for loading, for example, are arranged horizontally for storage and slope towards the unloading side 26 for unloading.

1-22. (canceled)

23. A transport system for transporting a material unit in material processing, the transport system comprising:
a container with a plurality of compartments; and
at least one loading device configured to load and/or unload the compartments,
wherein the at least one loading device comprises a carrier plate configured to transport the material unit to the container and/or from the container, and
wherein each compartment has a floor configured to receive the material unit from the carrier plate or to transfer the material unit to the carrier plate.

24. The transport system according to claim 23,
wherein the carrier plate is a conveyor belt and the floors are further conveyor belts,
wherein the conveyor belt of the at least one loading device is configured to selectively drive the further conveyor belts, and
wherein the conveyor belt of the at least one loading device comprises a first coupling element and each of the further conveyor belts comprises a second coupling element, the coupling elements being configured to be coupled mechanically to one another for loading and/or unloading.

25. The transport system according to claim 23,
wherein the at least one loading device comprises a loading device configured to load the compartments at a dispensing station and an unloading device configured to unload the compartments at a receiving station, and
wherein the transport system is configured such that the container is transported from the dispensing station to the receiving station after loading.

26. The transport system according to claim 25,
wherein each of the loading device and the unloading device are robots, and
wherein the carrier plate is a robot arm.

27. The transport system according to claim 23, wherein the carrier plate and/or the floor is inclined to allow sliding of the material unit by weight of the material unit during transfer.

28. The transport system according to claim 27, wherein the carrier plate is a conveyor belt and the floors are inclined.

29. The transport system according to claim 23, wherein each of the compartments has a selectively openable wall on an unloading side of the container.

30. The transport system according to claim 23, wherein the at least one loading device comprises a positioning device configured to vertically position the carrier plate.

31. The transport system according to claim 23, wherein the at least one loading device comprises a shifting device configured to shift an end of the carrier plate towards and from the container.

32. The transport system according to claim 23, wherein each of the compartments has at least one electronically readable marking in which information about the material unit located in an associated compartment is determinable from the readable marking.

33. The transport system according to claim 23, further comprising a control device configured to control a weight of the material unit.

34. A facility for the material processing, the facility comprising:
one or more transport systems according to claim 23.

35. The facility according to claim 34, wherein the one or more transport system is arranged at an interface to a dispensing station designed as a weighing device or at an interface to a receiving station designed as a mixing device.

36. A method for transporting the material unit in the material processing, the method comprising:
providing the transport system according to claim 23;
arranging a support plate of the loading device at a floor of one of the compartments; and
transferring the material unit between the at least one loading device and the container.

37. The method according to claim 36,
wherein the carrier plate is a conveyor belt and the floors are further conveyor belts,
wherein the conveyor belt of the loading device has a first coupling element and each of the further conveyor belts has a second coupling element,
wherein the coupling elements are configured to be coupled mechanically to one another for loading and/or unloading,
wherein the first coupling element is coupled with the second coupling element of one of the further conveyor belts, and
wherein the conveyor belt of the loading device selectively drives the one of the further conveyor belts for transferring the material unit between the loading device and the container.

38. The method according to claim 36,
wherein the transport system comprises a loading device for loading the compartments at a dispensing station and an unloading device for unloading the compartments at a receiving station, and
wherein the method further comprises transporting the container from the dispensing station to the receiving station after loading.

39. The method according to claim 38,
wherein the floors have an inclination, and
wherein the support plate is inclined for transfer.

40. The method according to claim 38, wherein the carrier plate is inserted into the compartment to be loaded for transferring the material unit.

41. The method of claim 38, wherein the material processing is a processing of rubber and/or silicon materials.

42. A transport system for transporting a material unit in material processing, the transport system comprising:
a container with a plurality of compartments; and
at least one loading device configured to load the compartments at a dispensing station and at least one unloading device configured to unload the compartments at a receiving station,
wherein each of the loading device and the unloading device has a carrier plate configured to transport the material unit to the container and/or from the container,
wherein each of the compartments has a floor configured to receive the material unit from the carrier plate or to transfer the material unit to the carrier plate,
wherein the carrier plate is a conveyor belt and the floors are further conveyor belts,
wherein the conveyor belt of the loading device are configured to selectively drive the further conveyor belts,
wherein the conveyor belt of the loading device has a first coupling element and each of the further conveyor belts has a second coupling element, the coupling elements being configured to be mechanically coupled to one another for loading and/or unloading, and
wherein the transport system is configured such that the container is transported from the dispensing station to the receiving station after loading.
